(19) United States
(12) Patent Application Publication
(10) Pub. No.: US 2004/0192807 A1
(43) Pub. Date: Sep. 30, 2004

(54) Resin composition for digital printing on metallic material and printing method using the same

(76) Inventors: Tae-Sun Kim, Shihung-City (KR); Sun-June Song, Daegu-City (KR); Se-Joong Chang, Daegu-City (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/459,454

(22) Filed: Jun. 12, 2003

(30) Foreign Application Priority Data
Mar. 24, 2003 (KR) 2003-18171

(51) Int. Cl. B05D 5/00; C03C 17/00; C09D 5/00

(52) U.S. Cl. 523/160; 427/402; 523/161

(57) ABSTRACT

The present invention relates to a resin composition for digital printing on a metallic material and a printing method using the resin composition. The resin composition comprises 40 to 70 wt % of at least one selected from acrylics, polyurethanes, polyvinyl alcohols and epoxy-based resins, 20 to 50 wt % of at least one diluent selected from methyl alcohol, isopropyl alcohol, ethyl acetate and toluene, 3 to 20 wt % of silica as a printing propriety imparting agent, 0.05 to 1 wt % of a wetting agent and 0.01 to 30 wt % of a curing agent. The resin composition can be applied directly to a metallic material through digital printing. Further, the resin composition is excellent in view of resolution, adhesivity and durability and allows printing processes to be shortened, thereby reducing costs.

### BACKGROUND OF THE INVENTION

1. Field of Invention

The present invention relates to a resin composition and printing method adapted to make printing on a metallic material such as a metal plate. More particularly, the present invention relates to an inexpensive resin composition with which digital printing can be made directly on a surface of a metallic material without using a transfer printing method so as to transmit a real image as it is owing to good adhesivity to the surface of the metallic material, good durability and high resolution, and a printing method using the same.

2. Description of the Prior Art

In general, printing methods may be divided into master printing and special printing depending on the kind of material on which printing will be made. The master printing means methods of implementing a specific image on a sheet of paper. The special printing means methods of implementing a specific image on a material other than paper, including silk screen printing, digital printing, transfer printing and the like.

The transfer printing among the special printing methods is a method of first printing a specific image to be implemented on a special paper used as a transfer paper, attaching the printed paper to a material and then heating it to complete the printing. The special paper used as a transfer paper includes a single sheet of paper such as chrome paper and china paper, a composite sheet of paper consisting of dual layers, and those obtained by laminating a support and then applying a polyvinyl-based resin thereon as a finishing process. The printing is made using a sublimation dye on the special paper.

Heretofore, a printing method using the transfer paper has been generally used for implementing an image on a metallic material and the like. The method comprises the steps of making digital printing on a separate transfer paper using the sublimation dye, performing thermal transfer (thermal bonding) by applying heat at a high temperature of 150 to 250° C. and then coating an ultraviolet blocking agent thereon to improve durability of the printed image. However, since the sublimation dye itself is vulnerable to ultraviolet rays, the ultraviolet blocking effects are low even when the ultraviolet blocking agent is coated. Further, a thermal transfer method is not only inadequate for printing of advertising materials, which require realization of precise patterns, due to a low resolution but also problematic in repeatedly implementing the same color because the color of the printed image is changed depending on slight variation in temperature during the hot thermal treatment.

In addition, there is a disadvantage in that a working efficiency is lowered due to addition of a work for beforehand printing an image to be implemented on the transfer paper, and thus, productivity and marketability are lowered due to increased costs.

As another method for supplementing the above disadvantages, there has been proposed a method of making digital printing directly on a metallic material without using a transfer paper. The method employs an ultraviolet curable resin. However, such a method has problems in that the cost is very high due to a specialty of the resin and the resolution is as low as the extent of maximum 720 dpi as compared with the conventional transfer method and the printed final surface is rough. Moreover, there is a critical problem in that if the printed metallic plate is subjected to forming processes such as a bending process, the resin printed on a bent portion of the plate is peeled off due to a low adhesive strength less than 7 kgf/cm².

Alternatively, there are a solvent-based resin composition essentially consisting of a solvent-based resin, and a product obtained by mixing a solvent-based resin with an ultraviolet curing agent. However, such products also have problems in that they are inadequate for universal use because an adhesive strength and resolution are low despite of their high costs.

### SUMMARY OF THE INVENTION

The present invention is conceived to solve the problems in the prior art. An object of the present invention is to provide a resin composition with which digital printing can be made directly on a metallic material without using a transfer paper and which is appropriate for printing of advertising materials, which require realization of precise images, owing to a superior resolution and is not deteriorated when printed on the metallic material such as a metal plate owing to a good adhesive strength and superior durability even though the metal plate is subjected to any forming processes such as a bending process.

Another object of the present invention is to provide a method of making digital printing on a metallic material using the resin composition according to the present invention.

### DESCRIPTION OF THE PREFERRED EMBODIMENTS

The present invention relates to a resin composition for digital printing on a metallic material, comprising 40 to 70 wt % of at least one selected from acrylics, polyurethanes, polyvinyl alcohols and epoxy-based resins with a solid content from 20 to 50%, 20 to 50 wt % of a diluent, 3 to 20 wt % of silica, 0.05 to 1 wt % of a wetting agent and 0.01 to 30 wt % of a curing agent.

Hereinafter, a preferred embodiment of the present invention will be described in detail.

### Resin Composition for Printing

The resin according to the present invention is at least one selected from acrylics, polyurethanes, polyvinyl alcohols and epoxy-based resins, preferably having a solid content from 20 to 50%. The resin content is preferably between 40 and 70 wt % based on the total composition. If two or more resins are selected for constituting the composition according to the present invention, the respective resins are mixed with one other in a range of 10 to 40 wt % such that the total content thereof should not be below 40 wt % or above 70 wt%.

The solid content of the resin constituting the resin composition according to the present invention is preferably between 20 and 50%. If the solid content is below 20%, the viscosity of the composition is decreased, and thus, it is difficult to form a coat on a metallic material when the resin is applied thereto before the digital printing and various problems occur in drying and the like. If the solid content is above 50%, the viscosity is increased, and thus, it is not possible to use a means for forming a coat such as a spray gun and undesirable conglomeration and partial coagulation of the resin solution occur.

Further, if the resin content is out of the range from 40 to 70 wt % proposed by the present invention, it is not desirable since there are disadvanategs in that the viscosity of the resin composition is difficult to maintain and the adhesivity and resolution thereof are reduced.

The diluent for use in the present invention can include methyl alcohol, isopropyl alcohol, ethyl acetate, toluene or the like for improving coating performance and dryability of the resin by regulating the viscosity. As for the diluent, a single diluent, a mixture of two diluents based on the same substance or a mixture of the three diluents may be used.

The content of the diluent according to the present invention is preferably between 20 and 50 wt%. If the content is below 20 wt%, there is a difficulty for dilution of the resin composition, which is a basic function as a diluent. Thus, the coating performance and dryability required for a raise of viscosity and printing propriety may be deteriorated. If the content is above 50 wt%, the solubility and viscosity are lowered as well as the adhesive strength desired in the present invention cannot be accomplished.

The silica employed in the present invention is used for improvement of the printing propriety. The mean particle diameter of the silica is preferably between 1 and 50 μm and its content is preferably between 3 and 20 wt%.

If the mean particle diameter of the silica is below 1 μm, the printing cost is increased due to repeated pulverization of particles and the printing propriety can also be lowered. If the mean particle diameter is above 50 μm, there are disadvantages in that a coated surface becomes rough due to large particles, and a loss of gloss and a peeling phenomenon of the silica itself may occur.

The silica content below 3 wt % is undesirable because the printing propriety is lowered. If the silica content is above 20 wt %, the excess silica results in problems such as peeling, reduction in the gloss, and deterioration of the printing propriety.

The wetting agent employed in the present invention is used for preventing bubble generation and reinforcing the adhesive performance and includes polyethylene glycol, and the like. The content of the wetting agent is preferably between 0.05 and 1 wt %. If the content of the wetting agent is out of the range proposed by the present invention, there are disadvantages in that the printing propriety and the adhesivity are decreased since the wetting function such as the prevention of bubble generation is lowered.

As for the curing agent used in the present invention, isocyanates, melamine formaldehydes, polyamide amines or the like can be employed. The content of the curing agent is preferably between 0.01 and 30 wt %. If the content of the curing agent is below 0.01 wt %, the adhesivity is decreased due to improper curing. On the contrary, if the content of the curing agent is above 30 wt %, there are problems such as viscosity inequality due to excessive curing and reduction in the printing propriety due to instability.

The respective components according to the present invention are mixed and stirred for at least 3 hours for uniform dispersion to obtain a uniform composition with a viscosity in a range of 200 to 400 cps.

### Printing Method

First, a metallic material is prepared by removing containments from a surface of the metallic material to obtain a uniform printing effect on the material. Then, the resin composition according to the present invention is first applied to the material to form a coat with a uniform thickness from about 3 to 50 μm in order to maintain stable adhesivity of digital printing inks. This process is generally called “primer coating.” The primer coat can be cured through a natural drying process. However, if rapid drying is needed, a thermal curing process can be carried out at 110 to 190° C. for 10 to 300 seconds on the basis of 2 m². If the thickness of the primer coat is below 3 μm, the good adhesivity and higher resolution which the resin composition according to the present invention shows cannot be maintained. If the thickness of the primer coat is above 50 μm, the object of the present invention cannot be accomplished because the primer coat itself is peeled off. If the primer coat is dried through the thermal curing process rather than the natural drying process, the temperature above 190° C. is undesirable because there are risks that a change in the color (yellowing) of the resin composition and dissolution of the coat may occur.

The metallic plate to which the resin composition according to the present invention can be applied includes a steel plate, a stainless plate, a copper plate, or other metal plates. If necessary, various materials including nonmetallic plates such as plywood, an acrylic plate, and a glass sheet may be employed. However, a metallic plate is most preferable.

After drying the primer coat, the digital printing is carried out using a plotter. This process is generally called “intermediate coating.” Inks for the digital printing can be divided into water-based inks, oil-based inks and ultraviolet curable inks. Among the water-based inks, there are a water-based pigment that is strong to ultraviolet rays and a water-based dye that is weak to ultraviolet rays. The water-based pigment that is strong to the ultraviolet rays is preferable.

Further, the oil-based inks include an oil ink and a solvent-based ink. If the solvent-based ink is used, there are advantages in that the adhesive strength is much stronger due to chemical bonding with the primer coat according to the present invention and resistance to the ultraviolet rays is increased, while there are disadvantages in that productivity is lowered due to reduction in the printing speed of the plotter and ink costs are high.

The ultraviolet curable ink is used in the form of a mixture thereof with an adhesive resin and thus its costs are high. Further, it is an ink that can be rapidly dried by means of ultraviolet illumination, and its printing propriety and adhesivity are extremely low and thus clear printing and the bending of a printed portion cannot be accomplished. Therefore, an ink using the water-based pigment is preferable for the intermediate coating in the present invention.

After the intermediate coating is completed, it is dried through the natural drying process or thermal drying process at the same temperature as the primer coating and the ultraviolet blocking resin is then applied with a thickness from 1 to 50 μm to protect the printed surface. This process is generally called “top coating.” The natural drying or thermal curing process can be employed for drying the top coat after completion of the top coating. However, the present invention is not specially limited thereto.

The processes for the primer coating and top coating may be integrated into a single process and then incorporated into the printing method using the resin composition for digital printing according to the present invention in order to shorten the printing processes and reduce costs. In this case, a mixing ratio of the top and primer coats is 40˜80:20˜60.

Further, the processes for the primer coating, intermediate coating and top coating may be integrated into a single process and then incorporated into the printing method using the resin composition for digital printing according to the present invention. In this case, an ICC profile, which is a device for controlling printing output of the plotter, is first adjusted. The primer coat, intermediate coat and top coat are mixed in a ratio of 30˜70:20˜60:10˜40 and then stirred for at least 3 hours to form a uniform mixture. Then, the printing using a direct spraying method and the thermal curing process can be carried out.

Next, the present invention will be described in detail in connection with examples. However, various modifications can be made thereto within the scope of the invention defined by the claims and the present invention is not limited to thereto.

### Example 1

(Preparation of Resin Composition)

30 wt % of polyurethane resin with a solid content of 35%, 30 wt % of acrylic resin with a solid content of 35%, 34.67 wt % of a mixed solution of methyl alcohol and isopropyl alcohol with a mixing ratio of 1:1, 5 wt % of silica with a mean particle diameter of 3˜8 μm, 0.3 wt % of polyethylene glycol, and 0.03 wt % of melamine formaldehyde were added and sufficiently stirred for 5 hours to prepare a composition with a viscosity of 270 cps.

(Preparation of Metallic Material)

A steel plate was selected and then contaminants were cleaned out from a surface of the steel plate to remove foreign materials from the plate.

(Printing)

The resin composition for digital printing prepared as such was sprayed on the surface of the plate from which foreign materials were removed to form a primer coat. The primer coat was set to be 6 μm in thickness and then dried at 150° C. for 90 seconds. Immediately after the drying, the digital printing was made with a water-based ink using a plotter and then thermally dried at 150° C. for 20 seconds. An ultraviolet blocking solution was finally applied on the dried surface with a thickness of 7 μm to form a top coat which in turn is thermally dried at 150° C. for 90 seconds. A finished product was obtained by packing with a protecting film.

### Example 2

30 wt % of polyurethane resin with a solid content of 40%, 32 wt % of acrylic resin with a solid content of 40%, 29.5 wt % of a mixed solution of methyl alcohol and isopropyl alcohol with a mixing ratio of 1:1 as a diluent, 8 wt % of silica as a printing propriety imparting agent with a mean particle diameter of 3 to 8 μm, 0.4 wt % of polyethylene glycol as a wetting agent, and 0.1 wt % of melamine formaldehyde resin as a curing agent were added and sufficiently stirred for 5 hours to prepare a uniform resin composition with a viscosity of 260 cps. The present example was carried out in the same manner as Example 1 except that the composition was applied to a copper plate.

### Example 3

30 wt % of polyurethane resin with a solid content of 30%, 30 wt % of acrylic resin with a solid content of 30%, 30.7 wt % of a mixed solution of methyl alcohol and isopropyl alcohol with a mixing ratio of 1:1 as a diluent, 9 wt % of silica as a printing propriety imparting agent with a mean particle diameter of 3 to 8 μm, 0.2 wt % of polyethylene glycol as a wetting agent, and 0.1 wt % of melamine formaldehyde resin as a curing agent were added and sufficiently stirred for 5 hours to prepare a resin composition with a viscosity of 280 cps. The present example was carried out in the same manner as Example 1 except that the composition was applied to an aluminum plate.

### Example 4

25 wt % of polyurethane resin with a solid content of 35%, 35 wt % of acrylic resin with a solid content of 35%, 33 wt % of a mixed solution of methyl alcohol and isopropyl alcohol with a mixing ratio of 1:1 as a diluent, 6.7 wt % of silica as a printing propriety imparting agent with a mean particle diameter of 3 to 8 μm, 0.23 wt % of polyethylene glycol as a wetting agent, and 0.07 wt % of melamine formaldehyde resin as a curing agent were added and sufficiently stirred for 5 hours to prepare a resin composition with a viscosity of 290 cps. The present example was carried out in the same manner as Example 1 except that the composition was applied to a glass sheet.

### Comparative Example 1

The printing method was carried out on a metal surface using a commercially available, conventional ultraviolet curable resin to obtain a finished product.

### Comparative Example 2

The printing method was carried out on a metal surface using a commercially available, conventional transfer paper to obtain a finished product.

The surfaces obtained through the digital printing according to Examples 1 to 4 were subjected to adhesive strength measurement, a bending test and resolution measurement. Examples 1 to 4 according to the present invention showed the adhesive strength of 15 to 25 kgf/cm² which is 90% as an average of 90% at a first test, 85% at a second test, 90% at a third test, 90% at a fourth test and 95% at a fifth test. On the contrary, Comparative Examples showed the adhesive strength of merely 5 to 10 kgf/cm². Further, when Examples 1 to 3 according to the present invention were bent ten times at 90 degrees and 360 degrees, respectively, through the bending test, the printed surface was not peeled off. However, Comparative Example 1 showed complete peeling of the printed surface and Comparative Example 2 showed partial peeling thereof.

The resolution of the surface obtained through the digital printing according to the present invention was 1,440 to 2,880 dpi that was superior to 720 dpi of Comparative Example 1.

### Determination of Physical Property

1) Adhesive strength (kgf/cm²): A cross-hatch method was employed. A scale mark was made using the blade of a knife and then an adhesive tape was attached thereto and detached therefrom to determine the adhesive strength based on the degree of peeling.

2) Bending test (the number of times): A metallic plate was bent at 90 degrees and 360 degrees, respectively. Then, the extent in which the bent, printed portion of the plate was separated from the plate was visually determined.

3) Resolution (dpi): the number of dots per 1 inch.

As described above, the resin composition for digital printing according to the present invention can be applied directly to a surface of a metallic material through the digital printing rather than a transfer method. Further, since the resin composition has a good adhesive strength and resolution, there are advantages in that the printed, metallic material can be processed into various forms and an actual image can be realized as it is.

Further, the resin for primer coating, the inexpensive water-based ink for digital printing and the resin for top coating can be mixed with one another and used as a single resin. Thus, there is an advantage in that the costs can be reduced and production processes can be shortened.

What is claimed is:

1. A resin composition for digital printing on a metallic material with a viscosity in a range of 200 to 400 cps, comprising 40 to 70 wt % of at least one selected from acrylics, polyurethanes, polyvinyl alcohols and epoxy-based resins with a solid content from 20 to 50%, 20 to 50 wt % of a diluent, 3 to 20 wt % of a printing propriety imparting agent, 0.05 to 1 wt % of a wetting agent and 0.01 to 30 wt % of a curing agent.

2. The resin composition as claimed in claim 1, wherein the composition comprises two or more resins and the respective resins are mixed in a range from 10 to 40 wt % such that the total amount thereof is from 40 to 70 wt%.

3. The resin composition as claimed in claim 1, wherein the diluent is at least one selected from methyl alcohol, isopropyl alcohol, ethyl acetate and toluene.

4. The resin composition as claimed in claim 1, wherein the printing propriety imparting agent is silica powders with a mean particle diameter from 1 to 50 μm.

5. The resin composition as claimed in claim 1, wherein the wetting agent is polyethylene glycol.

6. The resin composition as claimed in claim 1, wherein the curing agent is melamine formaldehydes, isocyanates or polyamide amines.

7. A printing method using a resin composition for digital printing on a metallic material, comprising the steps of:
selecting the metalli material and removing foreign materials from a surface of the metalli material;
forming a primer coat with a thickness from 3 to 50 μm using the resin composition with a viscosity in a range from 200 to 400 cps, comprising 40 to 70 wt % of at least one selected from acrylics, polyurethanes, polyvinyl alcohols and epoxy-based resins with a solid content from 20 to 50%, 20 to 50 wt % of a diluent, 3 to 20 wt % of a printing propriety imparting agent, 0.05 to 1 wt % of a wetting agent and 0.01 to 30 wt % of a curing agent and then drying the primer coat;
making the digital printing using a water-based ink and then drying the printed surface; and
forming a top coat with a thickness from 1 to 50 μm and then drying the top coat.

8. The method as claimed in claim 7, wherein the drying steps after the steps of forming the primer coat, making the digital printing and forming the top coat are performed through a natural drying process or a thermal drying process at 110 to 190° C. for 10 to 300 seconds.

9. The method as claimed in claim 7, wherein the resins for the top and primer coats are mixed with a mixing ratio of 40˜80:20˜60 and then applied in a single step.

10. The method as claimed in claim 7, wherein the resins for the primer coat, digital printing and top coat are mixed with a mixing ratio of 30˜70:20˜60:10˜40 and then printed in a single step.
